(19) United States
(12) Patent Application Publication
(10) Pub. No.: US 2026/0180210 A1
(43) Pub. Date: Jun. 25, 2026

(54) CONNECTOR TERMINAL, TERMINAL ASSEMBLY, CONNECTOR AND CONNECTOR ASSEMBLY

(71) Applicant: Tyco Electronics (Shanghai) Co., Ltd., Shanghai (CN)

(72) Inventor: Jiaoyong (Mac) Liu, Shanghai (CN)

(73) Assignee: Tyco Electronics (Shanghai) Co., Ltd., Shanghai (CN)

(21) Appl. No.: 19/428,522

(22) Filed: Dec. 22, 2025

(30) Foreign Application Priority Data
Dec. 23, 2024 (CN) 202411910293.7

(51) Int. Cl. H01R 4/48; H01R 9/18; H01R 9/20; H01R 9/22

(52) U.S. Cl. CPC H01R 4/4848; H01R 4/4814; H01R 4/4852; H01R 9/18; H01R 9/20; H01R 9/223

(57) ABSTRACT

A connector terminal includes a bottom plate and a pair of elastic arms. The bottom plate has two opposite sides in a width direction of the bottom plate. The pair of elastic arms are each connected to one side of the bottom plate. The connector terminal is an integral piece. The pair of elastic arms clamp a first busbar inserted between them. The bottom plate electrically contacts a second busbar.

### CROSS-REFERENCE TO RELATED APPLICATION

This application claims the benefit of the filing date under 35 U.S.C. § 119(a)-(d) of Chinese Patent Application No. CN202411910293.7 filed on Dec. 23, 2024, the whole disclosure of which is incorporated herein by reference.

### FIELD OF THE INVENTION

The present invention relates to a connector terminal and, more particularly, to a connector terminal, a terminal assembly comprising the connector terminal, a connector comprising the connector terminal or the terminal assembly, and a connector assembly comprising the connector.

### BACKGROUND OF THE INVENTION

A connector typically includes a housing and a terminal arranged within the housing. The terminal includes a pair of separated elastic arms, which are used to clamp the busbar inserted between them to achieve electrical connection between the terminal and the busbar. Due to the split structure of the terminal, when the busbar is offset or skewed relative to the predetermined insertion orientation, it will cause an imbalance in the contact force between the pair of elastic arms, which will result in unreliable electrical contact between the terminal and the busbar, especially in vibration situations, causing one elastic arm to separate from the busbar, seriously reducing the electrical contact performance.

### SUMMARY OF THE INVENTION

A connector terminal includes a bottom plate and a pair of elastic arms. The bottom plate has two opposite sides in a width direction of the bottom plate. The pair of elastic arms are each connected to one side of the bottom plate. The connector terminal is an integral piece. The pair of elastic arms clamp a first busbar inserted between them. The bottom plate electrically contacts a second busbar.

### BRIEF DESCRIPTION OF DRAWINGS

The invention will now be described by way of example with reference to the accompanying figures, of which:

FIG. 1 is a perspective view of a connector assembly according to an exemplary embodiment;

FIG. 2 is a cross-sectional view of the connector assembly of FIG. 1;

FIG. 3 is a perspective view of a connector according to an exemplary embodiment;

FIG. 4 is a cross-sectional view of the connector of FIG. 3;

FIG. 5 is a top perspective view of an insulation housing of the connector of FIG. 3;

FIG. 6 is a bottom perspective view of the insulation housing of FIG. 5;

FIG. 7 is a perspective view of a terminal assembly of the connector of FIG. 3;

FIG. 8 is a cross-sectional view of the terminal assembly of FIG. 7;

FIG. 9 is a perspective view of a connector terminal according to an exemplary embodiment;

FIG. 10 is a plan sectional view of the connector terminal of FIG. 9;

FIG. 11 is a perspective view of an auxiliary terminal of the connector of FIG. 3;

FIG. 12 is a plan sectional view of the auxiliary terminal of FIG. 11;

FIG. 13 is a plan sectional view of the terminal assembly of FIG. 7;

FIG. 14 is a plan sectional view of the terminal assembly of FIG. 7, and a first busbar, where the first busbar is inserted in a vertical direction; and

FIG. 15 is a plan sectional view of the terminal assembly of FIG. 7, and the first busbar of FIG. 14, where the first busbar is inserted in a skewed direction.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

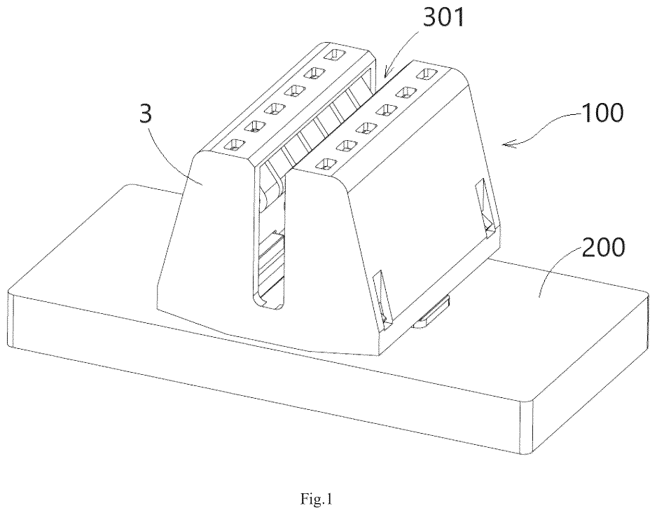

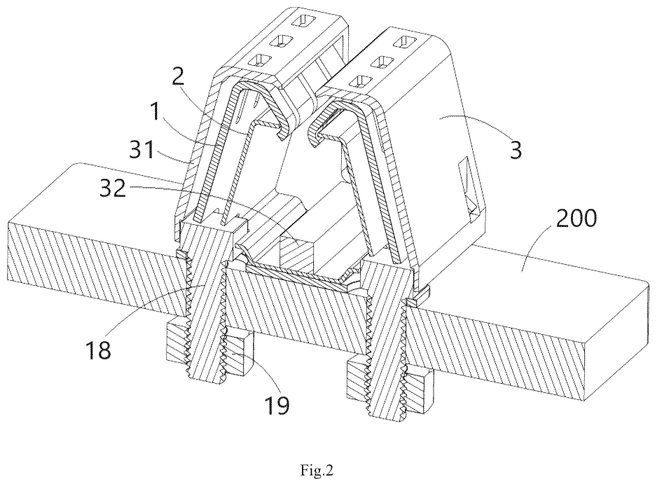

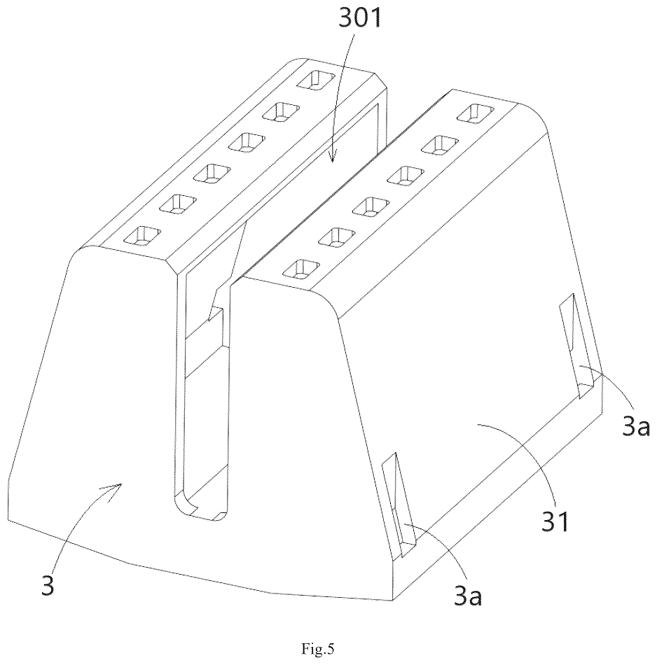

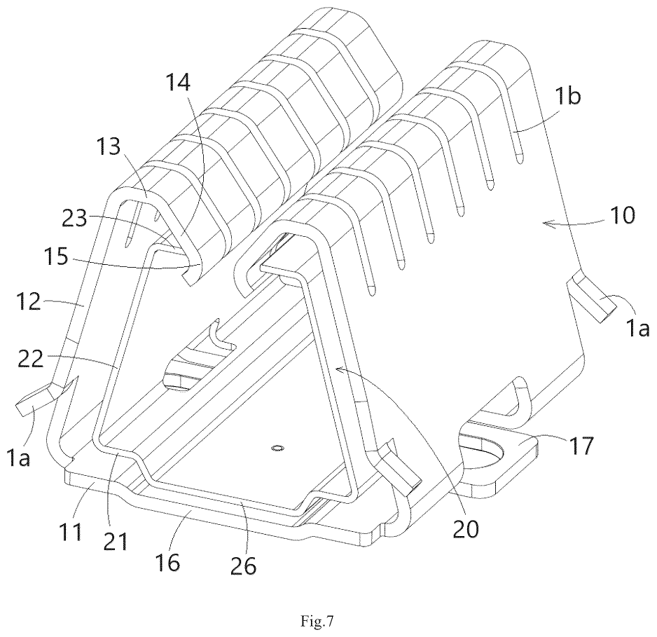

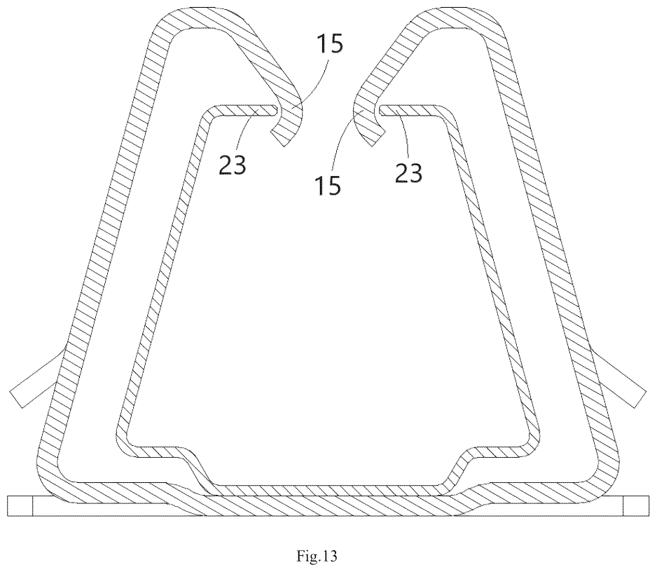

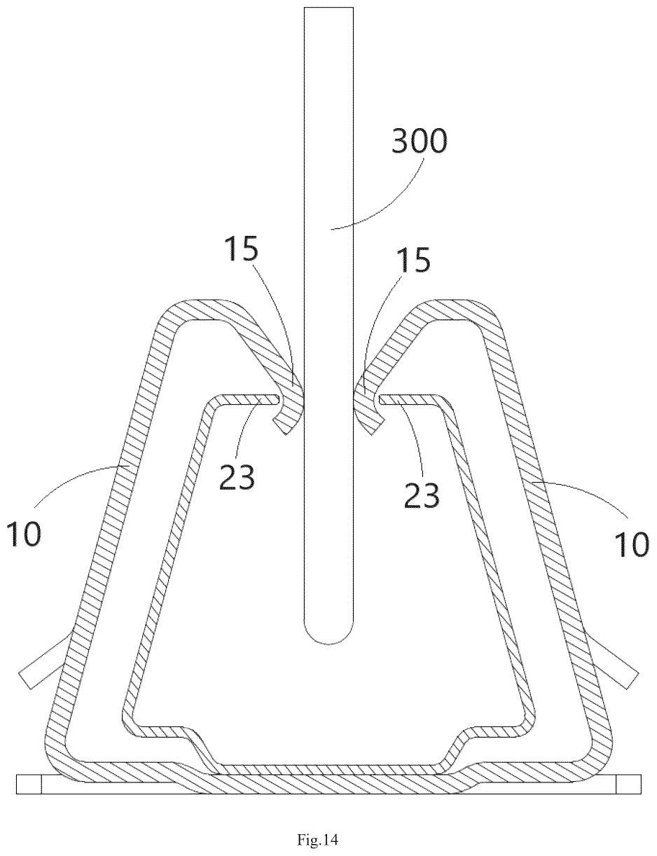

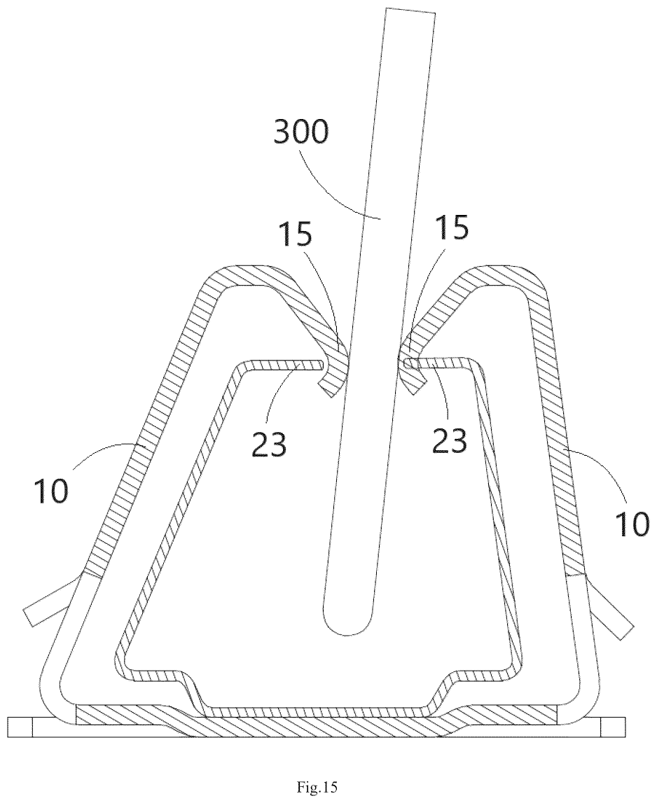

A connector terminal 1 will now be described with reference to FIGS. 1-15. As shown in FIGS. 7 and 9-10, the connector terminal 1 includes a bottom plate 16 and a pair of elastic arms 10. The bottom plate 16 has two opposite sides in its width direction X. The pair of elastic arms 10 are respectively connected to both sides of the bottom plate 16. The connector terminal 1 is an integral piece, and the pair of elastic arms 10 are used to clamp a first busbar 300, as shown in FIGS. 14-15, inserted between them. The bottom plate 16 is used for electrical contact with a second busbar 200, as shown in FIGS. 1-2.

As shown in FIGS. 7 and 9-10, the elastic arm 10 includes a first spring arm 11, a second spring arm 12, a third spring arm 13, a fourth spring arm 14, and an electrical contact portion 15. One end of the first spring arm 11 is connected to the bottom plate 16 and extends a first length in the width direction X of the bottom plate 16. The lower end of the second spring arm 12 is connected to the other end of the first spring arm 11 and extends upward obliquely for a second length. One end of the third spring arm 13 is connected to the upper end of the second spring arm 12 and extends a third length in the width direction X. One end of the fourth spring arm 14 is connected to the other end of the third spring arm 13 and extends downwards obliquely for a fourth length. The electrical contact portion 15 is connected to the other end of the fourth spring arm 14 and is bent in an arc shape, used for electrical contact with the first busbar 300. In the illustrated embodiment, the electrical contact portion 15 is located above the bottom plate 16 in the height direction Z.

The distance between the upper ends of the second spring arms 12 of the pair of elastic arms 10 is smaller than the distance between the lower ends of the second spring arms 12 of the pair of elastic arms 10. The distance between the electrical contact portions 15 of the pair of elastic arms 10 is slightly smaller than the thickness of the first busbar 300, so as to be able to simultaneously make electrical contact with both sides of the first busbar 300 inserted between them.

The connector terminal 1 is an integral stamped terminal formed by stamping a single metal sheet, and the elastic arm 10 is in a bent plate shape, making the connector terminal 1 in a dovetail shape.

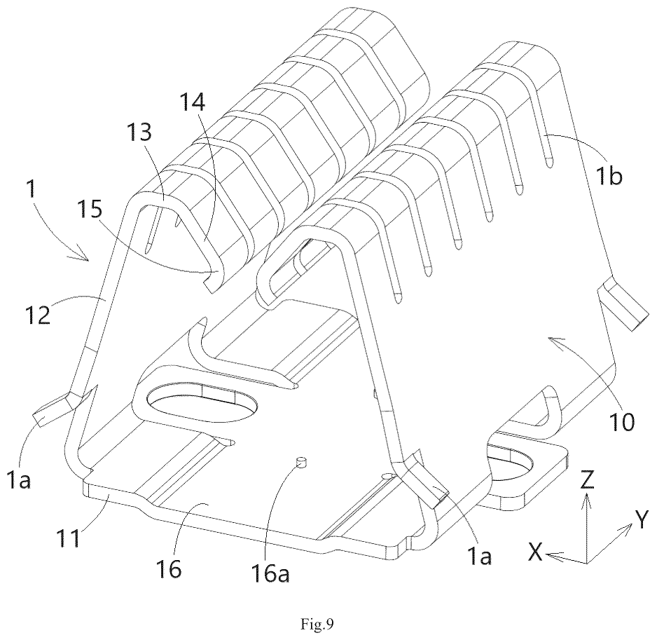

As shown in FIG. 9, multiple partition seams 1b are formed in the upper part of the elastic arm 10, and the multiple partition seams 1b are distributed at intervals in the length direction Y of the bottom plate 16. The multiple partition seams 1b extend from the upper part of the first spring arm 11 all the way to the end face of the electrical contact portion 15, making the upper part of the elastic arm 10 comb like.

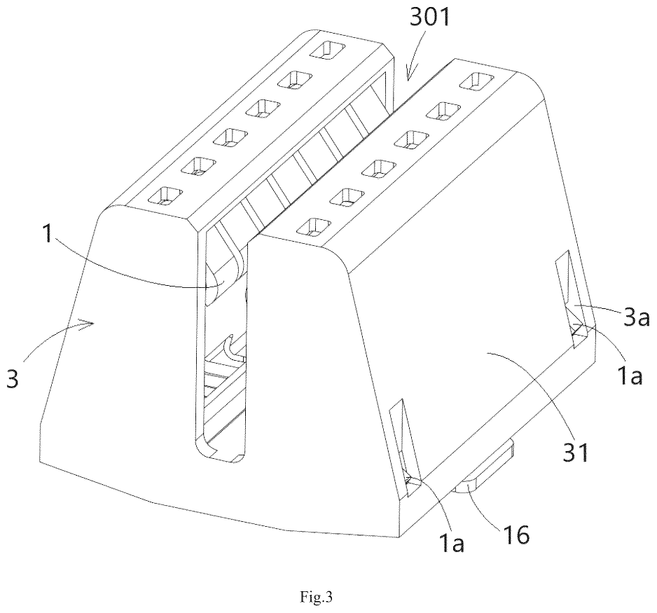

As shown in FIGS. 3, 7, and 9-10, an elastic buckle 1a is formed on the first spring arm 11. The elastic buckle 1a is used to engage with a snap slot 3a, as shown in FIGS. 3 and 5-6, on an insulation housing 3 of a connector 100 to fix the connector terminal 1 into the insulation housing 3.

As shown in FIGS. 7 and 9-10, the first spring arm 11 has front and rear sides opposite to each other in the length direction Y of the bottom plate 16, and the elastic buckle 1a is formed on each of the front and rear sides of the lower end of the first spring arm 11.

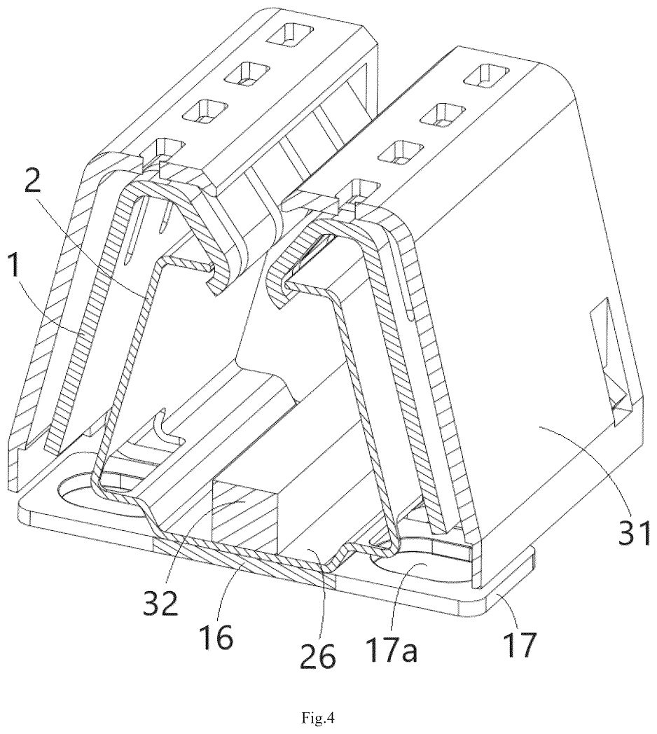

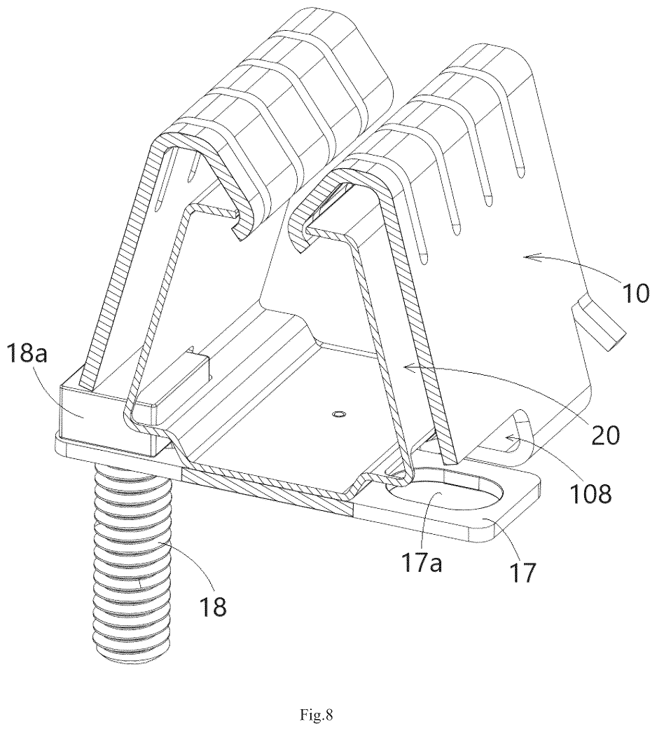

As shown in FIGS. 4, 7-8, and 10, the connector terminal 1 further includes a pair of connection ears 17. The pair of connection ears 17 are respectively connected to both sides of the bottom plate 16. A connection hole 17a, as shown in FIGS. 4 and 8, is formed in the connection ear 17 to allow a bolt 18, as shown in FIGS. 2 and 8, to pass through, so that the connector terminal 1 can be fastened to the second busbar 200 through the bolt 18. The connection hole 17a in the connection ear 17 is an elongated hole, and a window 108, as shown in FIG. 8, is formed in the bottom of the elastic arm 10 to accommodate the head 18a, as shown in FIG. 8, of the bolt 18. The connection ear 17 is located in the window 108.

When the connector terminal 1 is fastened to the second busbar 200 by the bolt 18, the bottom plate 16 of the connector terminal 1 is in electrical contact with the top surface of the second busbar 200, and there is a predetermined gap between the first spring arm 11 and the top surface of the second busbar 200.

An exemplary embodiment of a terminal assembly will now be described with reference to FIGS. 1-15. The terminal assembly includes the connector terminal 1 and an auxiliary terminal 2. As shown in FIGS. 2 and 4, the auxiliary terminal 2 is set in the connector terminal 1 to provide auxiliary contact force to the connector terminal 1.

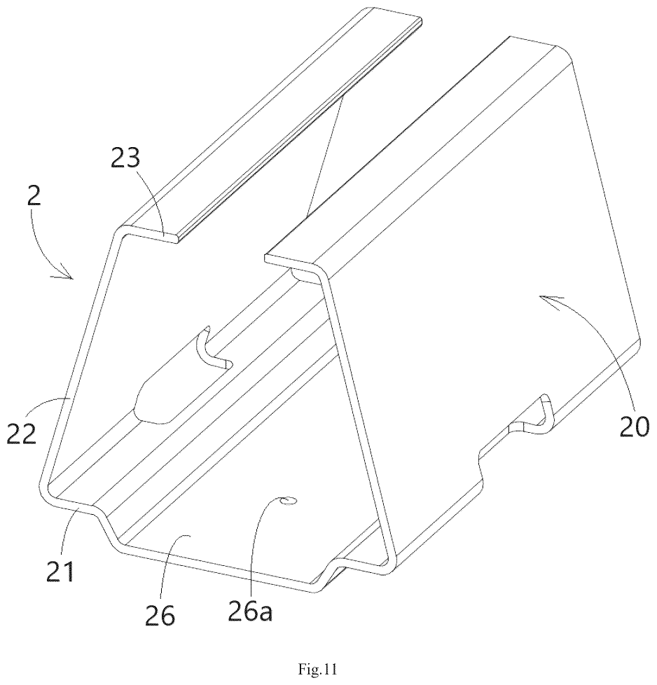

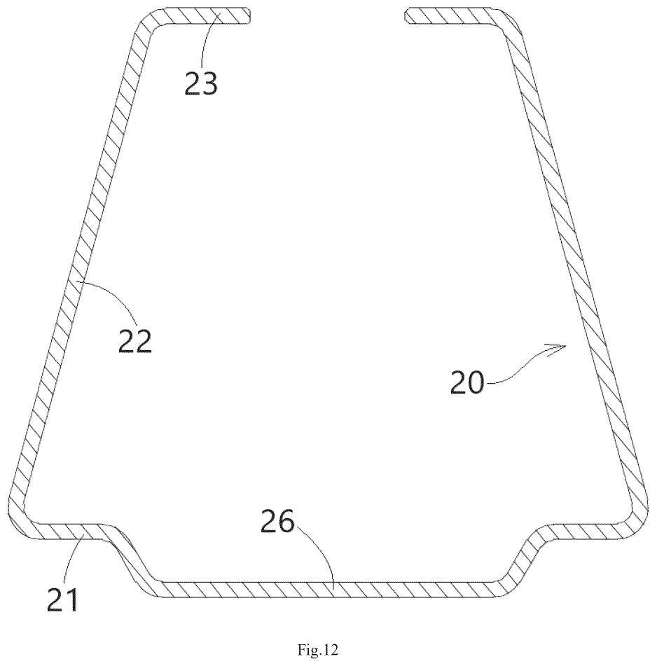

As shown in FIGS. 11-12, the auxiliary terminal 2 includes a base plate 26 and a pair of auxiliary spring arms 20. The base plate 26 is fixed to the top surface of the bottom plate 16 of the connector terminal 1. The pair of auxiliary spring arms 20 are respectively connected to both sides of the base plate 26. The ends of the pair of auxiliary spring arms 20 are respectively pressed against the electrical contact portions 15 of the ends of the pair of elastic arms 10 of the connector terminal 1 to increase the electrical contact force between the elastic arms 10 and the first busbar 300.

As shown in FIGS. 11-12, the auxiliary spring arm 20 includes a first auxiliary spring arm 21, a second auxiliary spring arm 22, and a third auxiliary spring arm 23. One end of the first auxiliary spring arm 21 is connected to the base plate 26 and extends in the width direction X of the bottom plate 16. The lower end of the second auxiliary spring arm 22 is connected to the other end of the first auxiliary spring arm 21 and extends obliquely upwards. One end of the third auxiliary spring arm 23 is connected to the upper end of the second auxiliary spring arm 22 and extends in the width direction X. As shown in FIGS. 14-15, the electrical contact portion 15 of the elastic arm 10 has an inner side for electrical contact with the first busbar 300 and an outer side opposite to the inner side, and the end of the third auxiliary spring arm 23 is pressed against the outer side of the electrical contact portion 15 of the elastic arm 10.

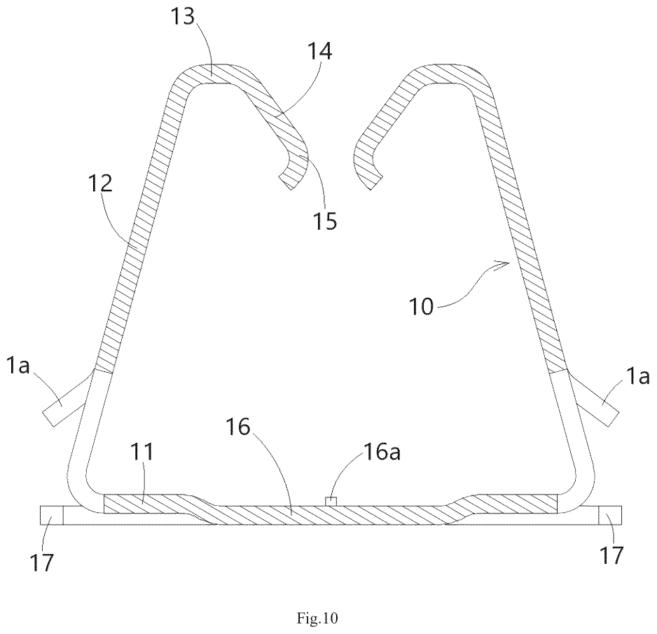

The base plate 26 of the auxiliary spring arm 20 is riveted, crimped, welded, or threaded to the bottom plate 16 of the connector terminal 1 to fix the base plate 26 to the bottom plate 16. A rivet post 16a, as shown in FIGS. 9-10, is formed on one of the base plate 26 of the auxiliary spring arm 20 and the bottom plate 16 of the connector terminal 1, and a rivet hole 26a, as shown in FIG. 11, is formed in the other one of the auxiliary spring arm 20 and the bottom plate 16. The rivet post 16a is riveted into the rivet hole 26a to rivet the base plate 26 and the bottom plate 16 together.

The terminal assembly further includes the bolt 18, as shown in FIGS. 2 and 8. The bolt 18 passes through the connection hole 17a in the connection ear 17 of the connector terminal 1, and is used to fasten the connector terminal 1 to the second busbar 200. The window 108, as shown in FIG. 8, is formed in the bottom of the elastic arm 10 and the auxiliary spring arm 20 to accommodate the head 18a of the bolt 18.

The auxiliary terminal 2 is an integral stamped terminal formed by stamping a single metal sheet, and the auxiliary spring arm 20 is in a bent plate shape, so that the auxiliary terminal 2 is in a dovetail shape.

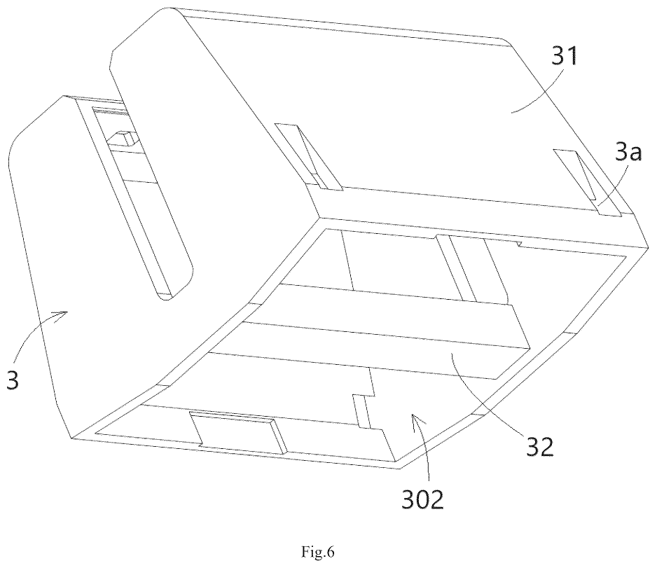

An exemplary embodiment of a connector 100 will now be described with reference to FIGS. 1-15. The connector 100 includes an insulation housing 3, as shown in FIGS. 1-3 and 5-6, and the aforementioned connector terminal 1 or terminal assembly. The insulation housing 3 has a bottom opening 302, as shown in FIG. 6, and a top slot 301, as shown in FIGS. 1, 3, and 5, opposite to the bottom opening 302. The connector terminal 1 or terminal assembly is installed in the insulation housing 3 through the bottom opening 302 and is suitable for clamping the first busbar 300 inserted through the top slot 301.

As shown in FIGS. 3 and 5-6, the snap slot 3a is formed on a side wall 31 of the insulation housing 3. The snap slot 3a is engaged with the elastic buckle 1a on the connector terminal 1 to fix the connector terminal 1 or terminal assembly into the insulation housing 3.

The insulation housing 3 includes a side wall 31, as shown in FIGS. 2-6, enclosing an inner cavity and a crossbeam 32, as shown in FIGS. 2, 4, and 6, connected to the bottom of the side wall 31. The crossbeam 32 extends along the length direction Y of the bottom plate 16 of the connector terminal 1 and rests against the top surface of the bottom plate 16 of the connector terminal 1 or the base plate 26 of the auxiliary terminal 2.

An exemplary embodiment of a connector assembly will now be described with reference to FIGS. 1-15. The connector assembly includes the aforementioned connector 100 and the first busbar 300. The first busbar 300 is inserted into the connector 100 through the top slot 301 of the insulation housing 3 of the connector 100. The pair of elastic arms 10 of connector terminal 1 clamp the first busbar 300 to achieve electrical connection between the connector terminal 1 and the first busbar 300.

The connector assembly further includes the second busbar 200. The second busbar 200 is fastened to the bottom of connector terminal 1 through the bolt 18 and a nut 19, as shown in FIG. 2, and makes electrical contact with the bottom surface of the bottom plate 16 of connector terminal 1. The bolt 18 passes through the connection ear 17 at the bottom of the connector terminal 1 and the second busbar 200, and is threaded with the nut 19.

As shown in FIG. 15, since the connector terminal 1 is an integral piece, it can ensure reliable electrical contact between the pair of elastic arms 10 of the connector terminal 1 and both sides of the first busbar 300 even when the first busbar 300 is offset or skewed during insertion, thereby improving the electrical contact performance of the connector terminal 1.

As described above, the connector 100 includes the connector terminal 1 and the auxiliary terminal 2. However, the present invention is not limited to the illustrated embodiments. For example, the connector 100 may only include the connector terminal 1 without the auxiliary terminal 2, which can reduce costs.

In the aforementioned exemplary embodiments according to the present invention, the connector terminal 1 is an integral piece, which ensures reliable electrical contact between the pair of elastic arms 10 of the connector terminal 1 and both sides of the first busbar 300 even when the first busbar 300 is offset or skewed during insertion, thereby improving the electrical contact performance of the connector terminal 1. In addition, in the aforementioned exemplary embodiments of the present invention, the length of each elastic arm 10 of the connector terminal 1 is longer, which further improves the electrical contact performance of the connector terminal 1 and reduces the risk of yielding of the connector terminal 1.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal, comprising:
a bottom plate having two opposite sides in a width direction of the bottom plate; and
a pair of elastic arms each connected to one side of the bottom plate, the connector terminal is an integral piece, the pair of elastic arms clamp a first busbar inserted between them, and the bottom plate electrically contacts a second busbar.

2. The connector terminal of claim 1, wherein each elastic arm includes:
a first spring arm, one end of the first spring arm is connected to the bottom plate and extends a first length in the width direction;
a second spring arm, a lower end of the second spring arm is connected to an other end of the first spring arm and obliquely extends upward for a second length;
a third spring arm, one end of the third spring arm is connected to an upper end of the second spring arm and extends a third length in the width direction;
a fourth spring arm, one end of the fourth spring arm is connected to an other end of the third spring arm and obliquely extends downward by a fourth length; and
an electrical contact portion which is connected to an other end of the fourth spring arm and is formed in a bent arc shape, the electrical contact portion electrically contacts the first busbar.

3. The connector terminal of claim 2, wherein a distance between upper ends of the second spring arms is smaller than a distance between lower ends of the second spring arms, and a distance between the electrical contact portions is smaller than a thickness of the first busbar, the electrical contact portions simultaneously electrically contact both sides of the first busbar inserted between them.

4. The connector terminal of claim 2, wherein the connector terminal is an integral stamped terminal formed by stamping a single metal sheet, and each elastic arm is formed in a bent plate shape, the connector terminal has a dovetail shape.

5. The connector terminal of claim 4, wherein a plurality of partition seams are formed in an upper part of each elastic arm, the plurality of partition seams are distributed at intervals in a length direction of the bottom plate, the plurality of partition seams extend from the upper part of the first spring arm to an end face of the electrical contact portion, the upper part of each elastic arm is comb shaped.

6. The connector terminal of claim 4, wherein an elastic buckle is formed on each first spring arm, the elastic buckle engages a snap slot on an insulation housing of a connector to fix the connector terminal into the insulation housing.

7. The connector terminal of claim 6, wherein each first spring arm has a front side and a rear side opposite to each other in a length direction of the bottom plate, the elastic buckle is formed on each of the front side and the rear side of the lower end of each first spring arm.

8. The connector terminal of claim 4, further comprising a pair of connection ears each connected to one side of the bottom plate, a connection hole is formed in each connection ear to allow a bolt to pass through, such that the connector terminal can be fastened to the second busbar through the bolt.

9. The connector terminal of claim 8, wherein the connection hole is an elongated hole, a window is formed in a bottom of each elastic arm to accommodate a head of the bolt, each connection ear is located in one window.

10. The connector terminal of claim 8, wherein when the connector terminal is fastened to the second busbar through the bolt, the bottom plate electrically contacts a top surface of the second busbar, there is a predetermined gap between the first spring arm and the top surface of the second busbar.

11. A terminal assembly, comprising:
a connector terminal including a bottom plate having two opposite sides in a width direction of the bottom plate, and a pair of elastic arms each connected to one side of the bottom plate, the connector terminal is an integral piece, the pair of elastic arms clamp a first busbar inserted between them, and the bottom plate electrically contacts a second busbar; and
an auxiliary terminal provided in the connector terminal, the auxiliary terminal provides auxiliary contact force to the connector terminal.

12. The terminal assembly of claim 11, wherein the auxiliary terminal has a base plate and a pair of auxiliary spring arms, the base plate is fixed to a top surface of the bottom plate of the connector terminal, each auxiliary spring arm is connected to one side of the base plate, ends of the pair of auxiliary spring arms are respectively pressed against electrical contact portions of ends of the pair of elastic arms of the connector terminal to improve an electrical contact force between the elastic arms and the first busbar.

13. The terminal assembly of claim 12, wherein each auxiliary spring arm includes:
a first auxiliary spring arm, one end of the first auxiliary spring arm is connected to the base plate and extends in the width direction of the bottom plate;
a second auxiliary spring arm, a lower end of the second auxiliary spring arm is connected to an other end of the first auxiliary spring arm and extends obliquely upwards; and
a third auxiliary spring arm, one end of the third auxiliary spring arm is connected to an upper end of the second auxiliary spring arm and extends in the width direction, an electrical contact portion of each elastic arm has an inner side for electrical contact with the first busbar and an outer side opposite to the inner side, the end of each third auxiliary spring arm rests against the outer side of one electrical contact portion.

14. The terminal assembly of claim 12, wherein the base plate of the auxiliary spring arm is riveted, crimped, welded or threaded to the bottom plate of the connector terminal to fix the base plate to the bottom plate.

15. The terminal assembly of claim 14, wherein a rivet post is formed on one of the base plate of the auxiliary spring arm and the bottom plate of the connector terminal, and a rivet hole is formed on the other of the auxiliary spring arm and the bottom plate of the connector terminal, the rivet post is riveted into the rivet hole to rivet the base plate and the bottom plate together.

16. The terminal assembly of claim 12, further comprising a bolt which passes through a connection hole formed in a connection ear of the connector terminal, the bolt fastens the connector terminal to the second busbar, a window is formed in the bottom of each elastic arm and each auxiliary elastic arm to accommodate a head of the bolt.

17. The connector terminal of claim 12, wherein the auxiliary terminal is an integral stamped terminal formed by stamping a single metal sheet, and each auxiliary spring arm is in a bent plate shape, the auxiliary terminal has a dovetail shape.

18. A connector, comprising:
an insulation housing having a bottom opening and a top slot opposite to the bottom opening; and
a connector terminal including a bottom plate and a pair of elastic arms, the bottom plate has two opposite sides in a width direction of the bottom plate, and the pair of elastic arms are each connected to one side of the bottom plate, the connector terminal is an integral piece, the pair of elastic arms clamp a first busbar inserted between them, and the bottom plate electrically contacts a second busbar; or
a terminal assembly including a connector terminal and an auxiliary terminal, the connector terminal includes a bottom plate having two opposite sides in a width direction of the bottom plate, and a pair of elastic arms each connected to one side of the bottom plate, the connector terminal is an integral piece, the pair of elastic arms clamp a first busbar inserted between them, and the bottom plate electrically contacts a second busbar, and the auxiliary terminal is provided in the connector terminal, the auxiliary terminal provides auxiliary contact force to the connector terminal, the connector terminal or the terminal assembly is installed in the insulation housing through the bottom opening and is suitable for clamping the first busbar inserted through the top slot.

19. The connector of claim 18, wherein a snap slot is formed on a side wall of the insulation housing, the snap slot is engaged with an elastic buckle on the connector terminal to fix the connector terminal or the terminal assembly into the insulation housing.

20. The connector of claim 18, wherein the insulation housing has a side wall enclosing an inner cavity and a crossbeam connected to a bottom of the side wall, the crossbeam extends along a length direction of the bottom plate and rests against a top surface of the bottom plate of the connector terminal or a base plate of the auxiliary terminal.

21. A connector assembly, comprising:
a connector, including an insulation housing, and a connector terminal or a terminal assembly, the insulation housing has a bottom opening and a top slot opposite to the bottom opening, the connector terminal includes a bottom plate and a pair of elastic arms, the bottom plate has two opposite sides in a width direction of the bottom plate, and the pair of elastic arms are each connected to one side of the bottom plate, the connector terminal is an integral piece, the terminal assembly includes a connector terminal and an auxiliary terminal, the connector terminal includes a bottom plate having two opposite sides in a width direction of the bottom plate, and a pair of elastic arms each connected to one side of the bottom plate, the connector terminal is an integral piece, and the auxiliary terminal is provided in the connector terminal, the auxiliary terminal provides auxiliary contact force to the connector terminal, the connector terminal or the terminal assembly is installed in the insulation housing through the bottom opening; and
a first busbar inserted into the connector through the top slot of the insulation housing, the pair of elastic arms of the connector terminal clamp the first busbar to electrically connect the connector terminal and the first busbar.

22. The connector assembly of claim 21, further comprising a second busbar fastened to the bottom of the connector terminal through a bolt and a nut, the second busbar is in electrical contact with a bottom surface of the bottom plate of the connector terminal, the bolt passes through a connection ear at a bottom of the connector terminal and the second busbar, the bolt is threaded with the nut.
